(19) United States
(12) Patent Application Publication
(10) Pub. No.: US 2007/0123127 A1
(43) Pub. Date: May 31, 2007

(54) Flame-resistant material

(76) Inventors: Jack Bouton Hirschmann JR., Dartmouth, MA (US); Thomas E. Neal, Guilford, CT (US)

Correspondence Address: HOLLAND & KNIGHT LLP, 10 ST. JAMES AVENUE, BOSTON, MA, 02116, US

(21) Appl. No.: 11/291,855

(22) Filed: Nov. 30, 2005

(51) Int. Cl. B32B 27/12; B32B 5/02

(52) U.S. Cl. 442/136; 442/394

(57) ABSTRACT

A flame-resistant material includes a para-aramid non-woven material substrate; and a polyurethane film containing approximately 10-20% by weight of antimony oxide (Sb₂O₃, Sb₂O₅) and decabromodiphenyl oxide containing a high level of aromatic bromine laminated to a first and a second surface of the para-aramid non-woven material substrate. The flame-resistant material is light weight, exhibits an exceptionally high level of protection from an arc flash hazard, and possesses a low particulate level that is required for clean room applications.

### BACKGROUND

The present invention relates to a flame-resistant material.

All fabrics will burn but some are more flammable than others. Untreated natural fibers such as cotton and linen burn more readily than silk and wool, which are more difficult to ignite and burn with a lower flame velocity.

The weight and weave of the fabric will affect how easily the material will ignite and burn. Recommended fabrics are materials with a tight weave. Heavy, tight weave fabrics will burn more slowly than loose weave, light fabrics of the same material. The surface texture of the fabric also affects flammability. Fabrics with long, loose, fluffy pile or “brushed” nap will ignite more readily than fabrics with a hard, tight surface and in some cases will result in flames flashing across the fabric surface.

Most synthetic fabrics, such as nylon, acrylic or polyester will begin to melt prior to ignition. However, once ignited, the fabrics melt rapidly. This hot, sticky, melted substance causes localized and extremely severe burns. When natural and synthetic fibers are blended, the hazard may increase because the combination of high rate of burning and fabric melting can readily result in serious burns.

### SUMMARY

The present invention relates generally to materials, and more particularly to a flame-resistant material.

In general, in one aspect, the invention features a material including a non-woven material substrate, and a flame-resistant polyurethane film laminated to a first and a second surface of the non-woven material substrate.

In embodiments, the non-woven material substrate can include a para-aramid non-woven material. The para-aramid non-woven material can weigh approximately 1.5 ounces per square yard (oz/yd²). The flame-resistant polyurethane film can include a polyurethane containing 10-20% antimony oxide (Sb₂O₃, Sb₂O₅) and decabromodiphenyl oxide containing a high level of aromatic bromine. The polyurethane can include an approximate 1:3 ratio of the antimony oxide (Sb₂O₃, Sb₂O₅) and decabromodiphenyl oxide containing the high level of aromatic bromine. The flame-resistant polyurethane film laminated to the first surface of the non-woven material substrate can contain carbon to enable antistatic performance characteristics.

In another aspect, the invention features a flame-resistant material including a para-aramid non-woven material substrate, and a polyurethane film containing approximately 10-20% by weight of antimony oxide (Sb₂O₃, Sb₂O₅) and decabromodiphenyl oxide containing a high level of aromatic bromine laminated to a first and a second surface of the para-aramid non-woven material substrate.

In embodiments, the para-aramid non-woven material substrate weighs approximately 1.5 ounces per square yard (oz/yd²). The polyurethane film can include an approximate 1:3 ratio of the antimony oxide (Sb₂O₃, Sb₂O₅) and decabromodiphenyl oxide containing the high level of aromatic bromine. The polyurethane film laminated to the first surface of the para-aramid non-woven material substrate can include carbon to enable antistatic performance characteristics.

In another aspect, the invention features a flame-resistant non-woven coated material including a para-aramid non-woven material substrate weighing approximately 1.5 ounces per square yard (oz/yd²), and a polyurethane film containing approximately 10-20% by weight of antimony oxide (Sb₂O₃, Sb₂O₅) and decabromodiphenyl oxide containing a high level of aromatic bromine laminated to a first and a second surface of the para-aramid non-woven material substrate.

In embodiments, the polyurethane film can include an approximate 1:3 ratio of the antimony oxide (Sb₂O₃, Sb₂O₅) and decabromodiphenyl oxide containing the high level of aromatic bromine. The polyurethane film laminated to the first surface of the para-aramid non-woven material substrate can include carbon to enable antistatic performance characteristics.

In further embodiments, the polyurethane film laminated to the second surface of the substrate can be replaced with a polytetrafluoroethylene (PTFE) film laminated to the second side of the substrate. In additional embodiments, the polyurethane film can replaced with a polyvinylchloride (PVC) film including flame retardants laminated to both sides of the substrate.

In another aspect, the invention features a material including a non-woven material substrate, and a flame-resistant polyurethane coated on a first and a second surface of the non-woven material substrate.

In embodiments, the flame-resistant polyurethane can be replaced with polyvinylchloride (PVC) including flame retardants coating both surfaces of the non-woven material substrate.

In another aspect, the invention features a material including a woven material substrate, and a flame-resistant polyurethane film laminated to a first and a second surface of the woven material substrate.

In embodiments, the polyurethane film laminated to the second surface of the substrate can be replaced with polytetrafluoroethylene (PTFE). The polyurethane film can be replaced with polyvinylchloride (PVC) including flame retardants laminated to both surfaces of the woven material substrate.

In another aspect, the invention features a material including a woven material substrate, and a flame-resistant polyurethane coated on a first and a second surface of the woven material substrate.

In embodiments, the polyurethane can replaced with polyvinylchloride (PVC) including flame retardants coating both surfaces of the woven material substrate.

The invention can be implemented to realize one or more of the following advantages.

The dual coated material is flame-resistant (FR) and light weight.

The dual coated material exhibits an exceptionally high level of protection from an arc flash hazard.

The dual coated material possesses a low particulate level that is required for clean room applications.

One implementation of the invention provides all of the above advantages.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a cross section of an exemplary flame-resistant material.

FIG. 2 is a listing of exemplary test results.

FIG. 3 is a listing of exemplary test results.

FIG. 4 is a listing of exemplary test results.

FIG. 5 is a listing of exemplary test results.

Like reference numbers and designations in the various drawings indicate like

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

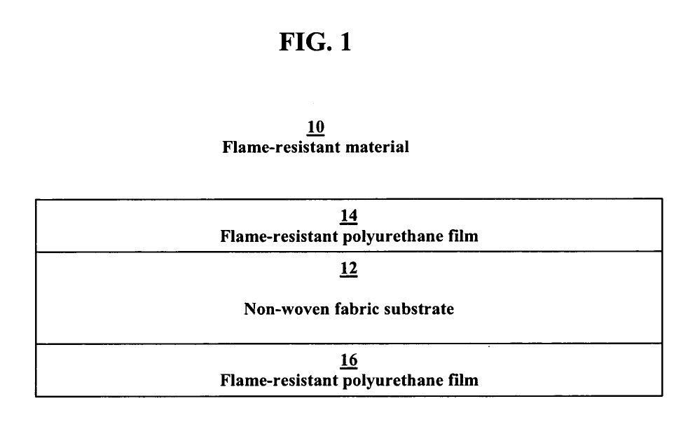

As shown in FIG. 1, a cross section of an exemplary flame-resistant material 10 includes a non-woven material substrate 12 having polyurethane films 14, 16 containing flame retardants (FR) laminated to both sides of the material substrate 12. One of the FR polyurethane films, film 14, for example, includes carbon to enable antistatic performance. Laminating both sides of the material substrate 12 with FR polyurethane films 14, 16 prevents a generation of particles that could contaminate a clean room environment.

In a particular example, the non-woven material substrate 12 weighs approximately 1.5 ounce/square yard (oz/yd²) para-aramid non-woven material. Para-aramid non-woven materials are available as Kevlar® from E. I. DuPont, as Technora® from Teijin, and as Twaron® from Teijin Twaron.

The FR polyurethane laminated films 14, 16 include flame retardants so that the laminated films 14, 16 are flame-resistant. The material substrate 12 provides strength during, for example, a high temperature arc flash exposure that results in added break open resistance. The laminated films 14, 16 on both sides of the material substrate 12 enable a lightweight but highly effective heat barrier during an arc flash exposure.

The FR polyurethane films 14, 16 include antimony oxide (Sb₂O₃, Sb₂O₅) and decabromodiphenyl oxide containing a high level of aromatic bromine added to polyurethane. Decabromodiphenyl oxide containing a high level of aromatic bromine is available as Saytex® 102E from Albemarle Corporation, for example. In one particular example, one part of antimony oxide and three parts of decabromodiphenyl oxide containing a high level of aromatic bromine are used for a total loading of 10% to 20% for the polyurethane.

In another particular example, the flame-resistant material 10 can include a non-woven meta-aramid/para-aramid blend substrate with a polyurethane film laminated to a first side of the substrate and a polytetrafluoroethylene (PTFE) film laminated to a second side of the substrate. In this example, only the polyurethane film includes flame retardants.

In another example, the flame-resistant material 10 can include a non-woven meta-aramid/para-aramid substrate with a FR polyvinylchloride (PVC) film laminated to both sides of the substrate.

In still another example, the flame-resistant material 10 can include a woven meta-aramid/FR rayon blend substrate with polyurethane film laminated on a first side of the substrate and a PTFE film laminated to a second side of the substrate. In this example, only the polyurethane film includes flame retardants.

Flame-resistant material 10 has many applications. For example, flame-resistant material 10 can be used to design clothing for electricians working in clean rooms and other workers who are required to work in clean environments in which there are flash fire hazards or arc flash hazards. In general, a clean room is a manufacturing environment that has a low level of environmental pollutants such as dust, airborne microbes, aerosol particles and chemical vapors. More specifically, a clean room has a controlled level of contamination that is specified by the number of particles per meter-cubed and by particle size.

Flame-resistant material 10 can effectively replace existing flame resistant clean room materials, such as those made of Nomex® aramid filament yarns from E. I. DuPont. Nomex® filament material is approximately five times the price of flame-resistant material 10. In addition, Nomex® filament material is in short supply due to its use in military clothing.

The following are brief descriptions of selected critical performance specifications impacting industrial flame-resistant clothing. Each standard specification uses test methods to verify performance, and defines the minimum or maximum test performance required on each test to comply with the standard.

The ASTM F1506 Standard Performance Specification for Textile Materials for Wearing Apparel for Use by Electrical Workers Exposed to Momentary Electric Arc and Related Thermal Hazards specification provides performance requirements for clothing worn by electric utility workers and other personnel working around energized parts. In addition to non-thermal requirements, the standard requires the material to be flame-resistant; that is, to not ignite and continue to burn after exposure to an ignition source. Flame resistance is measured using ASTM D6413 Vertical Flame test (max. 2 sec afterflame and 6 in. char length). The standard also includes a requirement of reporting an Arc Rating. The Arc Rating is either the Arc Thermal Performance Value (ATPV) or Arc Breakopen Value (EBT) as measured by ASTM F1959 Arc Thermal Performance Test.

The NFPA 2112 Standard for Flame-Resistant Garments for Protection of Industrial Personnel against Flash Fire is the first US standard that specifically addresses the need for industrial flame-resistant uniforms. This standard requires FR materials to pass a comprehensive battery of thermal tests, including
Vertical flammability (2 sec after flame and 4 in. char length)
Thermal Protective Performance (TPP) test (minimum TPP of 6 acl/cm2 spaced and 3 cal/cm2 in contact)
Thermal Stability Test (material must not melt or drip, separate or ignite after 5 minutes in a 500° F. oven)
Thermal Shrinkage Test (less than 10% after 5 min in a 500° F. oven)
ASTM F1930 Thermal Mannequin Test (maximum 50% body burn after 3 sec flash fire)

NFPA 70E Standard for Electrical Safety Requirements for Employee Workplaces 2004 Edition addresses electrical hazard threats that are present in the workplace. NFPA 70E requires that the employer shall document the incident energy exposure of the worker when it has been determined that the worker will be performing tasks within the flash protection boundary.

NFPA 70E bases incident energy exposure levels on the working distance of the employee's face and chest areas from a prospective arc source for the specific task to be performed. Flame Resistant Clothing and Personal Protective Equipment shall be used by the employee, and an adequate level of protection based upon the incident energy exposure associated with the specific task shall be worn.

In comparative testing, Nomex® filament material weighs 5 oz/yd² or 1.47 times higher than flame-resistant material 10 at 3.4 oz/yd². Nomex's arc rating is 6.3 or 57% of the arc rating of 11 for flame-resistant material 10. Nomex® filament material meets NFPA 70E Hazard Risk Category 1 (HRC1, 4 cal/cm²) while flame-resistant material 10 meets Hazard Risk Category 2 (HRC2, 8 cal/cm²).

Most clean room workers do not require FR clean room garments. The standard clean room garment is constructed from polyester filament yarns that are woven very tightly to prevent particles from moving through the material. Polyester filament, when exposed to an arc flash or flash fire, melts and ignites, thus causing serious burn injuries to the wearer.

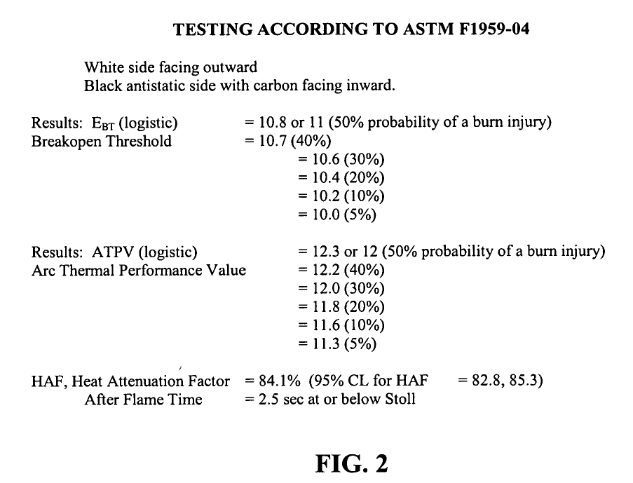

In FIG. 2, arc testing results for flame-resistant material 10 according to ASTM F1959 are illustrated.

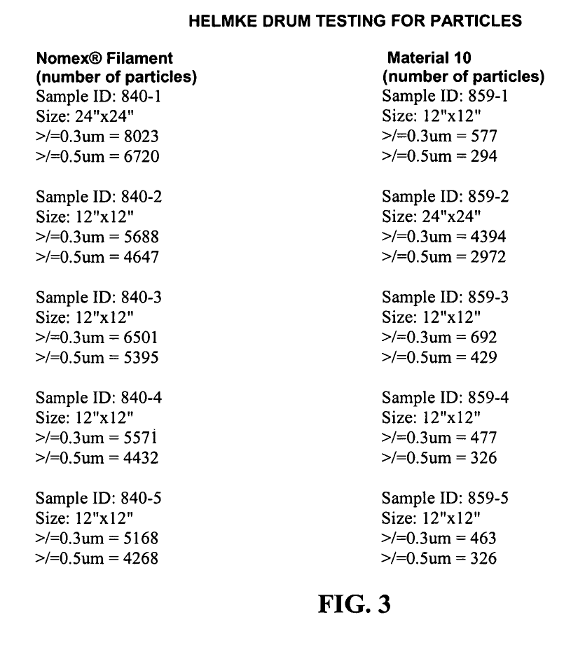

In FIG. 3, Helmke drum test results for flame-resistant material 10 and Nomex® filament material are illustrated. In the Helmke drum test, a garment or consumable is tumbled in a stainless steel drum while particle counts are taken in the air above it. An airborne particle counter is used to determine the number of particles less than 0.3 microns per cubic foot of air (number of particles>0.3μ per ft³). This test was initially developed for barrier garments, such as those made from laminates or coated materials, but has been adapted to all types of clean room supplies. This test measures easily releasable particles on the item's surface.

The flame-resistant material 10 passes the vertical flame test specified in ASTM D6413. The flame-resistant material 10 exhibits less than a 6 inch char length and less than 2 seconds of after flame, which meets the requirements specified in ASTM F1506-2a.

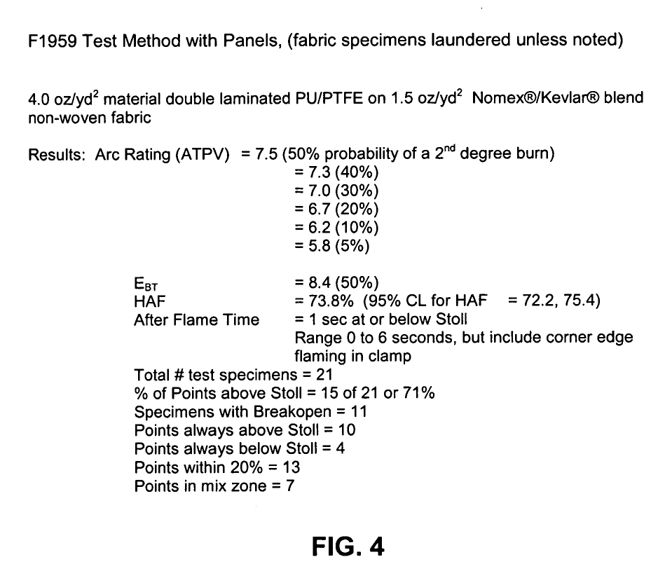

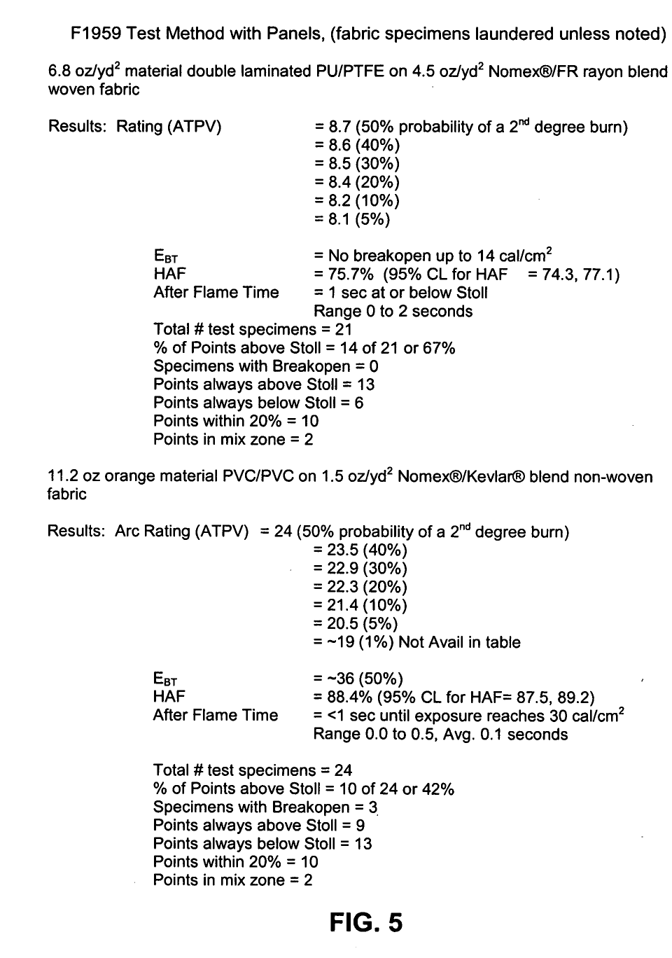

As shown in FIG. 4 and FIG. 5, additional illustrative F1959 test results are listed.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A material comprising:
a non-woven material substrate; and
a flame-resistant polyurethane film laminated to a first and a second surface of the non-woven material substrate.

2. The material of claim 1 wherein the non-woven material substrate comprises a para-aramid non-woven material.

3. The material of claim 2 wherein the para-aramid non-woven material weighs approximately 1.5 ounces per square yard (oz/yd²).

4. The material of claim 1 wherein the flame-resistant polyurethane film comprises a polyurethane containing 10-20% antimony oxide (Sb₂O₃, Sb₂O₅) and decabromodiphenyl oxide containing a high level of aromatic bromine.

5. The material of claim 4 wherein the polyurethane comprises an approximate 1:3 ratio of the antimony oxide (Sb₂O₃, Sb₂O₅) and decabromodiphenyl oxide containing the high level of aromatic bromine.

6. The material of claim 1 wherein the flame-resistant polyurethane film laminated to the first surface of the non-woven material substrate contains carbon to enable antistatic performance characteristics.

7. A flame-resistant material comprising:
a para-aramid non-woven material substrate; and
a polyurethane film containing approximately 10-20% by weight of antimony oxide (Sb₂O₃, Sb₂O₅) and decabromodiphenyl oxide containing a high level of aromatic bromine laminated to a first and a second surface of the para-aramid non-woven material substrate.

8. The flame-resistant material of claim 7 wherein the para-aramid non-woven material substrate weighs approximately 1.5 ounces per square yard (oz/yd²).

9. The flame-resistant material of claim 7 wherein the polyurethane film comprises an approximate 1:3 ratio of the antimony oxide (Sb₂O₃, Sb₂O₅) and decabromodiphenyl oxide containing the high level of aromatic bromine.

10. The flame-resistant material of claim 7 wherein the polyurethane film laminated to the first surface of the para-aramid non-woven material substrate comprises carbon to enable antistatic performance characteristics.

11. A flame-resistant non-woven coated material comprising:
a para-aramid non-woven material substrate weighing approximately 1.5 ounces per square yard (oz/yd²); and
a polyurethane film containing approximately 10-20% by weight of antimony oxide (Sb₂O₃, Sb₂O₅) and decabromodiphenyl oxide containing a high level of aromatic bromine laminated to a first and a second surface of the para-aramid non-woven material substrate.

12. The flame-resistant non-woven coated material of claim 111 wherein the polyurethane film comprises an approximate 1:3 ratio of the antimony oxide (Sb₂O₃, Sb₂O₅) and decabromodiphenyl oxide containing the high level of aromatic bromine.

13. The flame-resistant material of claim 11 wherein the polyurethane film laminated to the first surface of the para-aramid non-woven material substrate comprises carbon to enable antistatic performance characteristics.

14. The flame-resistant material of claim 11 wherein the polyurethane film laminated to the second surface of the substrate is replaced with a polytetrafluoroethylene (PTFE) film laminated to the second side of the substrate.

15. The flame-resistant material of claim 11 wherein the polyurethane film is replaced with a polyvinylchloride (PVC) film including flame retardants laminated to both sides of the substrate.

16. A material comprising:
a non-woven material substrate; and
a flame-resistant polyurethane coated on a first and a second surface of the non-woven material substrate.

17. The material of claim 16 wherein the flame-resistant polyurethane is replaced with polyvinylchloride (PVC) including flame retardants coating both surfaces of the non-woven material substrate.

18. A material comprising:
a woven material substrate; and
a flame-resistant polyurethane film laminated to a first and a second surface of the woven material substrate.

19. The material of claim 18 wherein the polyurethane film laminated to the second surface of the substrate is replaced with polytetrafluoroethylene (PTFE).

20. The material of claim 18 wherein the polyurethane film is replaced with polyvinylchloride (PVC) including flame retardants laminated to both surfaces of the woven material substrate.

21. A material comprising:
a woven material substrate; and
a flame-resistant polyurethane coated on a first and a second surface of the woven material substrate.

22. The material of claim 21 wherein the polyurethane is replaced with polyvinylchloride (PVC) including flame retardants coating both surfaces of the woven material substrate.
